(19) United States
(12) Patent Application Publication
(10) Pub. No.: US 2005/0009415 A1
(43) Pub. Date: Jan. 13, 2005

(54) Cable and connector assemblies and methods of making same

(76) Inventor: Morgan T. Johnson, Portland, OR (US)

Correspondence Address: RAYMOND J. WERNER, 2056 NW ALOCLEK DRIVE, SUITE 314, HILLSBORO, OR, 97124, US

(21) Appl. No.: 10/855,070

(22) Filed: May 26, 2004

Related U.S. Application Data
(63) Continuation-in-part of application No. 10/789,287, filed on Feb. 27, 2004.
(60) Provisional application No. 60/451,112, filed on Feb. 27, 2003.
(60) Provisional application No. 60/450,844, filed on Feb. 28, 2003.

(51) Int. Cl. H01R 12/24; H01R 4/02

(52) U.S. Cl. 439/865; 439/874

(57) ABSTRACT

Cable and connector assemblies in which one or more conductors have transmission line characteristics, and methods of producing such assemblies include providing a body with openings therethrough, providing a conductive ground shield, at least at the inner surface of the openings, disposing at least one conductor through at least one opening, and disposing mechanical support means for positioning the at least one conductor within the at least one opening. The body may include structures for attaching the mechanical support means thereto. The body may be highly conductive so as to form the ground shield, or conductive inserts, or conductive coatings may be provided along the inner surface of the openings. The body may be formed from a unitary piece, or may be formed from a stack of slices. Alternatively, the body may be formed from a printed circuit board having plated-through holes. The body may act as a heat sink.

### RELATED APPLICATIONS

This non-provisional patent application is a continuation-in-part of co-pending application Ser. No. 10/789,287, entitled “CABLE ASSEMBLIES AND METHODS OF MAKING SAME”, filed 27 Feb. 2004, which claimed the benefit of earlier filed provisional applications 60/451,112, filed 27 Feb. 2003; and 60/450,844, filed 28 Feb. 2003, and which is incorporated herein by reference; and this non-provisional application further claims the benefit of co-pending provisional application 60/473,408, filed 27 May 2003, which is incorporated herein by reference.

### FIELD OF THE INVENTION

The present invention relates generally to cable assemblies, and the manufacturing thereof. More particularly, the present invention relates to the structure and formation of assemblies having transmission line characteristics which are suitable for low-cost manufacturing.

### BACKGROUND

Electrical interconnections, that is, pathways for electrical signals are most often provided by way of wired connections. Many types of wire and wire connector mechanisms are known. For example, solid wire and braided wire, in both bare and insulated forms, are known for carrying, that is providing a pathway for, electrical signals. Certain configurations of conductive wires, dielectrics, shields, and insulators, provide for a unique class of electrical characteristics. In particular, cables, such as the well-known coaxial cable arrangement (commonly referred to simply as coax) are referred to as transmission lines because of their particular electrical characteristics. As will be appreciated by those skilled in this field, transmission line characteristics have proven to have utility in conducting high frequency signals with a smaller amount of attenuation than would normally occur in a conventional wire, which does not possess such transmission line characteristics.

Conventional cables having the desirable transmission line characteristics, such as coax cables, typically include a conductor surrounded by a dielectric material, an electrically conductive shield surrounding the dielectric material and an insulator surrounding the shield. Twinax conductors, which are known in this field, are similarly constructed, but include two different conductors in the central portion of the cable so as to carry differential signals. Conventional cables, such as those described above, have desirable electrical characteristics, but are relatively expensive.

Advances in integrated circuit manufacturing and digital systems architecture have resulted in electronic products incorporating integrated circuits that operate at frequencies high enough that many of the signal paths in these electronic products can benefit significantly from the application of cables and connectors providing desirable transmission line characteristics.

What is needed are cable assemblies suitable for high frequency applications, that have desirable electrical and physical properties, and which are less expensive to manufacture than conventional cables.

### BRIEF DESCRIPTION OF THE DRAWINGS

FIG. 1 is a cross-sectional view of a coaxial cable assembly in accordance with the present invention which shows a highly conductive body having openings therethrough, conductors disposed in the openings, the conductors being held in place by dielectric sheets, such as for example, polyimide, disposed on top and bottom surfaces of the body.

FIG. 2 is a top view of the coaxial cable assembly of FIG. 1.

FIG. 3 is a partial cross-sectional view of a coaxial cable assembly similar to that shown in FIG. 1, but relying on metallized inner surfaces of the openings, rather than upon having a highly conductive body, to form the ground shield surrounding the conductor disposed in the openings.

FIG. 4 is a cross-sectional view of a coaxial cable assembly in accordance with the present invention which shows a body formed from a multi-layer printed circuit board (PCB), with openings formed from plated-through holes, with the plated through holes contacting embedded metal layers of the PCB, and with the conductors centered and held in place by dielectric inserts, or sheets, disposed at the top and bottom of plated-through holes.

FIG. 5 is a cross-sectional view of a partially assembled coaxial transmission line, in accordance with the present invention, in which a pre-fabricated sub-assembly including a center conductor surrounded by a dielectric material and the dielectric material surrounded by a metal or metallized outer layer is inserted into an opening of the body of a cable assembly.

FIG. 6 is a partial cross-sectional view of an alternative cable assembly, in accordance with the present invention, in which the conductors are centered and held in position by a printed circuit board rather than a dielectric sheet; and which shows the printed circuit board fitted to the body of the cable assembly by means of vias in the printed circuit board fitted over posts formed from material of the body.

FIG. 7 is a partial cross-sectional view of an alternative cable assembly, in accordance with the present invention, in which a printed circuit board, for positioning and holding the conductors, is itself attached to the body of the cable assembly by means of being riveted to the body.

FIG. 8 is a partial cross-sectional view of an alternative cable assembly, in accordance with the present invention, in which a secondary injection molding of, for example, Teflon or PTFE, provides a dielectric material within the opening disposed between the shield and the conductor.

FIG. 9 is cross-sectional view of a twinax cable assembly, in accordance with the present invention, which shows a highly conductive body having openings therethrough, two conductors disposed in each of the openings, the conductors being held in place by dielectric sheets, such as for example, polyimide, disposed on top and bottom surfaces of the body.

FIG. 10 is top view of the twinax cable assembly of FIG. 9.

FIG. 11 illustrates a first sub-assembly including a plurality of vertically oriented conductors supported by a connecting web, and more particularly illustrates the supporting rings of the connecting web that hold the conductors, and the locking bars of the connecting web that are inserted into recesses in the slices to prevent lateral movements.

FIG. 12 illustrates a second sub-assembly in which the first sub-assembly is combined with a first slice by inserting the connecting web into recesses of the first slice, thereby holding the conductors positioned within the openings of the first slice, and spaced apart from the slice itself.

FIG. 13 illustrates a third sub-assembly in which the second sub-assembly is combined with a second slice which is fitted over the conductors and engaged with the connecting web which also connects with the first slice. Recesses suitable for engaging with a further connecting web are shown in the top surface of the second slice.

FIGS. 14-17 illustrate the components and assembly of a twinax cable in accordance with the present invention.

FIG. 14 shows a pair of conductors that are used to form a twinaxial communication path.

FIG. 15 shows an illustrative body having openings through which pairs of conductors are placed to form a plurality of twinaxial communication paths.

FIG. 16 illustrates the spatial relationship between pairs of conductors and support members that are used to position those conductors within a body.

FIG. 17 illustrates an assembly in which a plurality of twinaxial communication paths are provided through a common body.

### SUMMARY OF THE INVENTION

Briefly, cable and connector assemblies in which one or more conductors have transmission line characteristics, and methods of producing such assemblies in a low-cost manner include providing a body with openings therethrough, providing a conductive ground shield, at least at the inner surface of the openings, disposing at least one conductor through at least one opening, and disposing mechanical support means for positioning the at least one conductor such that it is desirably positioned within the at least one opening. The body may be formed from a unitary piece, or may be formed from a stack of slices. Alternatively, the body may be formed from a printed circuit board having plated-through holes.

In a further aspect of the present invention, the body includes structures for attaching the mechanical support means thereto.

In a further aspect of the present invention, the body serves as a heat sink.

### DETAILED DESCRIPTION

It would be desirable to provide methods and apparatus for providing low cost cable and connector assemblies wherein the signal paths have transmission line characteristics.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Various embodiments of the present invention provide cable and/or connector assemblies, such as for example, semi-rigid cable assemblies, with transmission line characteristics, high packing density of conductors, low attenuation for high frequency signals, and low cost of manufacturing. Assemblies in accordance with the present invention, which are suitable for use as cables or connectors, include providing a body with openings therethrough, providing a conductive ground shield, at least at the inner surface of the openings, disposing one or more conductors through the at least one opening, and disposing mechanical support means for positioning the one or more conductors such that they are desirably positioned within the at least one opening. In typical embodiments of the present invention, an air dielectric is disposed between the conductors and ground shield, but the present invention is not limited to any particular dielectric.

In some embodiments or the present invention, the distinction between a cable and a connector is small or non-existent because the body that provides a ground shield to the conductors which run through it, is the same structure that provides for physical connection between the body and conductors on one hand, and circuit components or connectors on the other hand.

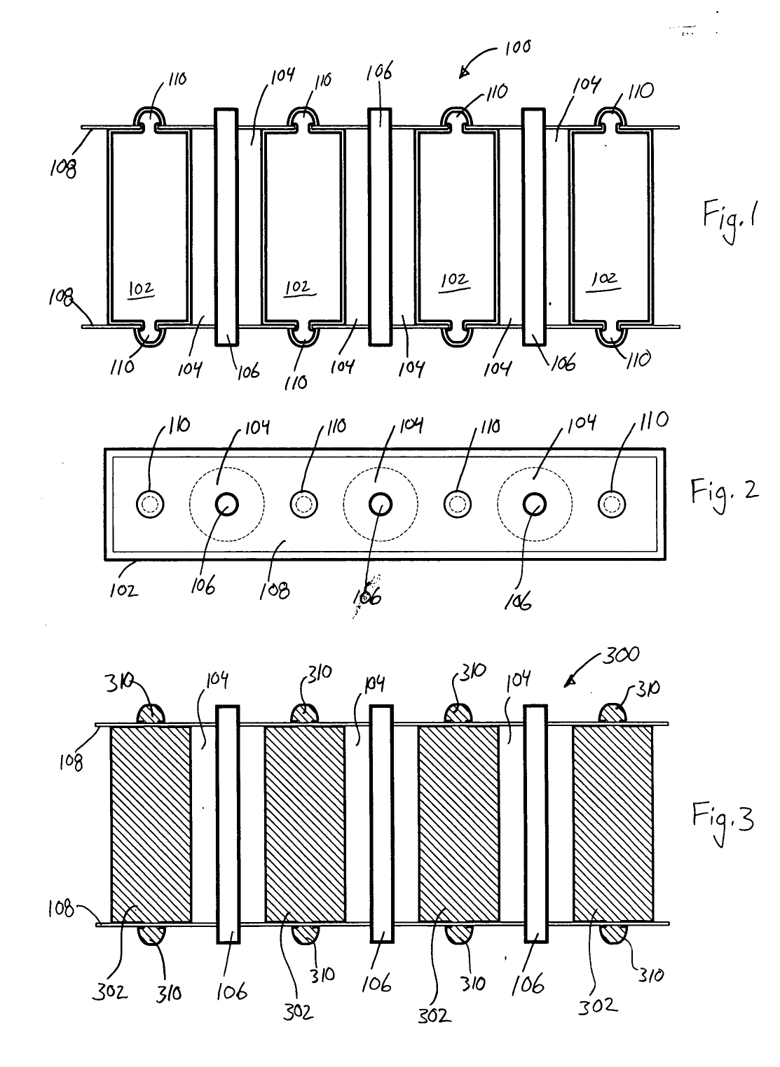

Referring to FIG. 1, a coaxial cable assembly 100 in accordance with the present invention, shown in cross-section, includes a highly conductive body 102 having openings 104 therethrough, conductors 106 disposed in openings 104, conductors 106 being held in place by dielectric sheets 108, such as for example, polyimide, disposed on top and bottom surfaces of body 102. Body 102 may include structures 110 over which dielectric 108 are fitted and attached. In one aspect of the present invention, body 102 itself is comprised of an electrically conductive material. By way of example and not limitation, body 102 may be formed from an aluminum block. In this way, body 102 itself serves as a ground shield for conductors 106 when it is connected to an electrical ground node. It is noted that, for purposes of acting as a ground shield, any suitably electrically conductive material other aluminum may be used to form the unitary body having openings through which one or more conductors are disposed. One advantage of using a material such as aluminum is that body 102 then has thermal transfer properties suitable for removing heat from a component or board. It is noted that, for purposes of acting as a heat sink, any suitable thermally conductive material other than aluminum may be used to form the body. Such an electrically conductive body 102 may also be formed as a stack of conductive slices rather than as a unitary body. For purposes of heat dissipation, body 102 may be formed with fins or other suitable structures which increase surface area thereby facilitating transfer of undesired thermal energy to, for example, the air surrounding the body, which in turn can be circulated by well known methods such as fans.

The conductive slices referred to above may be formed from a highly conductive material such as a metal. Alternatively, the conductive slices may be formed from a material such as a plastic that has conductive particles disposed therein. In a further alternative, the conductive slices may be formed from a material such as plastic that has conductive threads (referred to as “steel wool”) disposed therein. The amount and type of conductive particle or threads used in the slices can be determined based the effective resistivity desired for a particular application. Additionally, the effective resistivity of such plastic slices having conductive material therein can be reduced by the inclusion of highly conductive posts that traverse the stack of slices, and which can further serve to mechanically bind the slices and/or to attach the dielectric sheets which hold the conductors in place.

FIG. 2 is a top view of the coaxial cable assembly of FIG. 1.

Referring to FIG. 3, a partial cross-sectional view of a coaxial cable assembly 300 is shown which relies on electrically conductive inner surfaces of openings 104, rather than upon having a highly conductive body, to form the ground shield surrounding the conductor disposed in the openings. In this illustrative embodiment of the present invention, a body 302 is not electrically conductive, and the electrical conductivity of the inner surface of openings 104 needed for formation of the ground shields is provided by depositing, or otherwise forming, an electrically conductive coating, such as a metal coating, upon the inner surface of openings 104. Formation of an electrically conductive coating can be achieved by any suitable method including but not limited to, sputtering, evaporating, chemical vapor deposition, and vacuum deposition. In another aspect of the present invention electrical conductivity of the inner surface of the openings is provided by inserting a conductive tube, or sleeve, in the various openings so as to provide the conductivity required for a ground shield. In another aspect, the body is formed of a plurality of stacked slices, each slice having openings therethrough which are aligned with each other to form the openings through the body. Such slices may be formed from an insulating material such as, but not limited to, plastic. In this way, the size, or length, of the assembly may be determined by combining an arbitrary number of slices. The slices may each have the same thickness, or the slices may be chosen as a combination of various thicknesses so as to most closely achieve the desired cable length.

In one embodiment of the present invention, the slices may be held in place by posts inserted therethrough which “clamp” the slices together. Such posts may also hold the dielectric sheets in place. The posts may be electrically conductive and connected to a ground node in order to reduce the effective resistance in the ground shield formed by the body of the cable assembly. Alternatively, the slices may be formed to fit together in a tongue and groove fashion. In a further alternative the slices may be held in place against lateral forces by the insertion of locking bars that fit partly into recesses in one slice, and fit the remainder of the locking bars into recesses in an opposing face of the superjacent slice. In a still further alternative, the top and bottom slices may be different from intermediate slices of the stack, in that the top and bottom slices include structures for attaching the dielectric sheets.

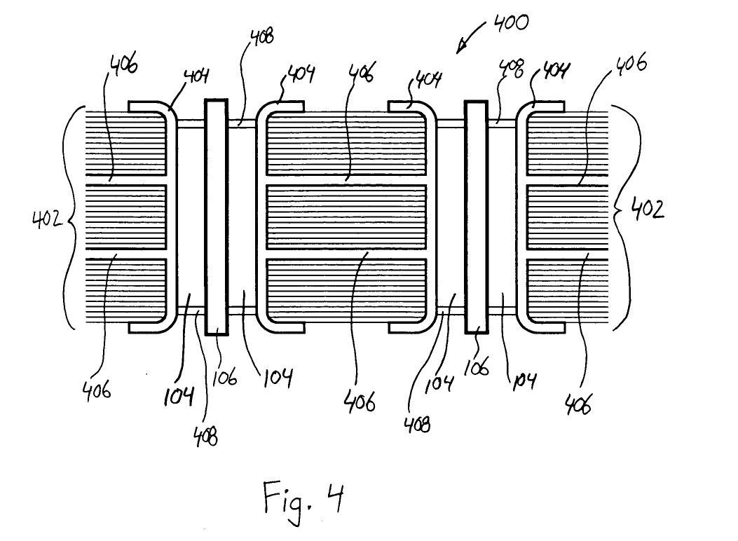

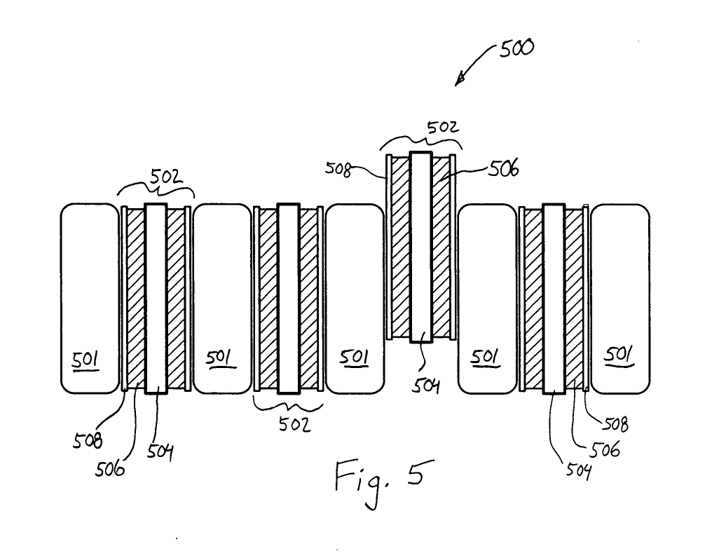

Referring to FIG. 4, a cross-sectional view of a coaxial cable assembly 400 in accordance with the present invention is shown which includes a body 402 formed from a multi-layer printed circuit board (PCB), with openings 104 formed from plated-through holes 404, with plated through holes 404 contacting embedded metal layers 406 of the PCB, and with conductors 106 centered and held in place by dielectric inserts 408, or sheets, disposed at the top and bottom of plated-through holes 404. In this illustrative embodiment of the present invention, body 402 is formed from a printed circuit board 402 having plated through holes 404. The plating in the holes serves as the ground shield. In a multi-layer printed circuit board, connection between the plating and a ground node may be made by means of conductive layers 406 embedded within the printed circuit board.

Referring to FIG. 5, a cross-sectional view of a partially assembled coaxial transmission line assembly 500, in accordance with the present invention, is shown which includes a pre-fabricated sub-assembly 502 including a center conductor 504 surrounded by a dielectric material 506, and dielectric material 506 surrounded by a metal or metallized outer layer 508 that is inserted into an opening of a body 501. Sub-assembly 502 may be inserted into the opening by pressing in sub-assembly 502, but the present invention is not limited to any particular method of positioning sub-assembly 502 within the opening of body 501. In this illustrative embodiment body 501 may be formed from an electrically insulating material since ground shield 508 is provided as part of subassembly 502. In an alternative embodiment, body 501 may be formed from an electrically conductive material.

Referring to FIG. 6, a partial cross-sectional view of an alternative cable assembly 600, in accordance with the present invention, is shown in which conductors 106 are centered and held in position by a printed circuit board 602 rather than a dielectric sheet. FIG. 6 further shows printed circuit board 602 fitted to a body 604 of cable assembly 600 by means of vias 603 in printed circuit board 602 which are fitted over posts 605 formed from material of body 604. In this illustrative embodiment, printed circuit board 602 is formed of a material that is electrically insulating, and body 604 is formed of an electrically conductive material. Body 604 forms the ground shield for conductors 106. Assembly 600, as shown in FIG. 6, has an air dielectric between conductors 106 and body 604.

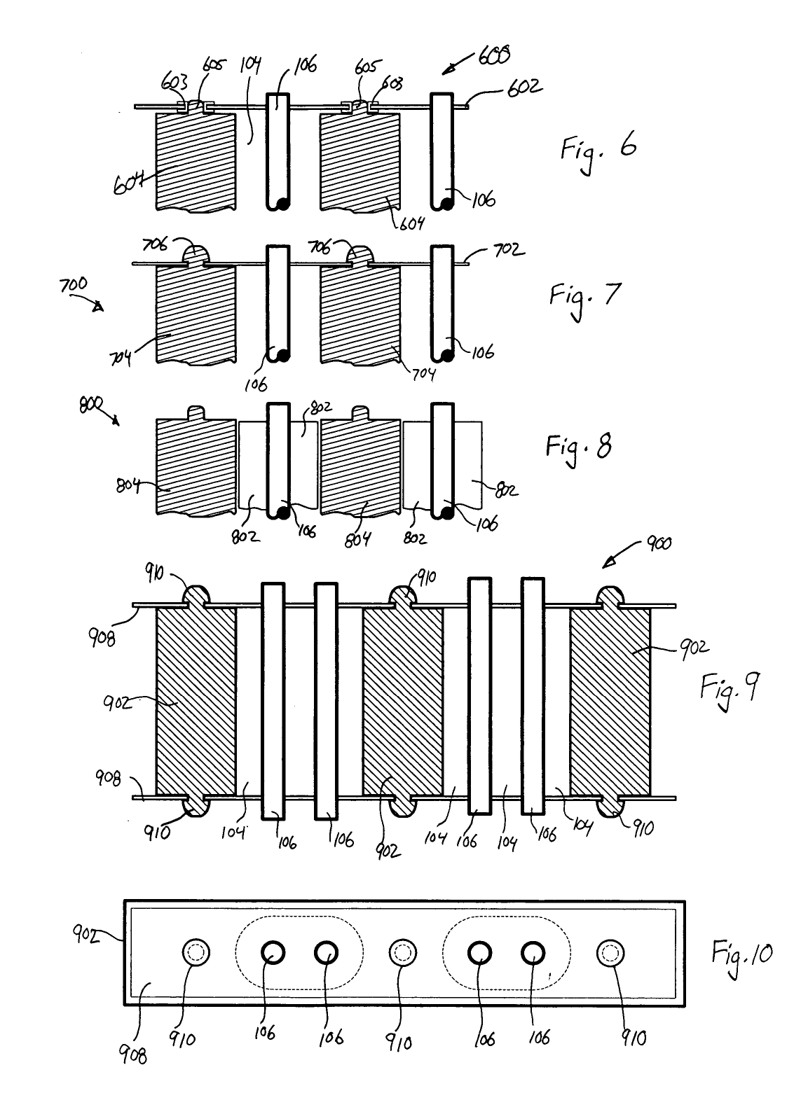

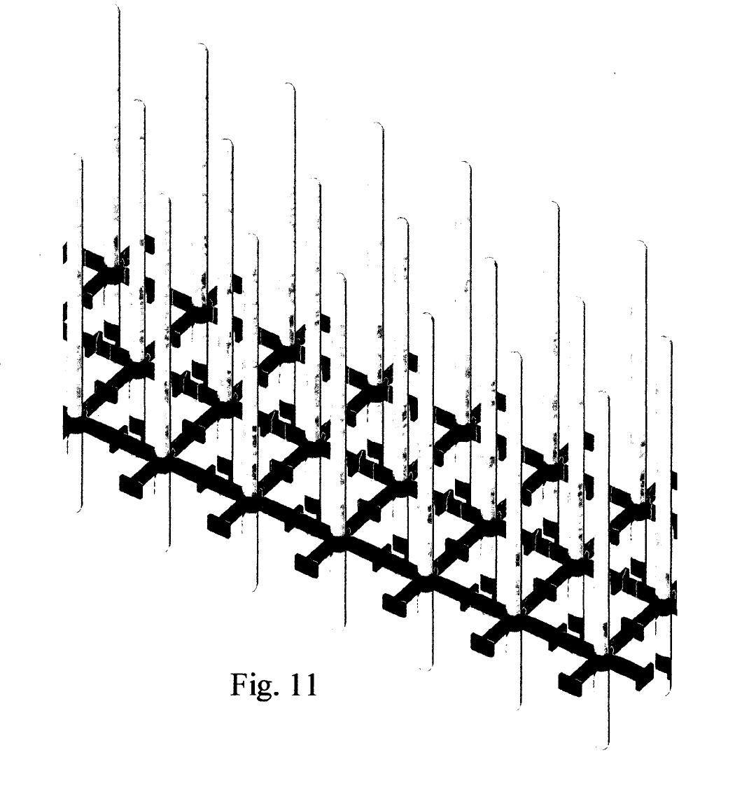

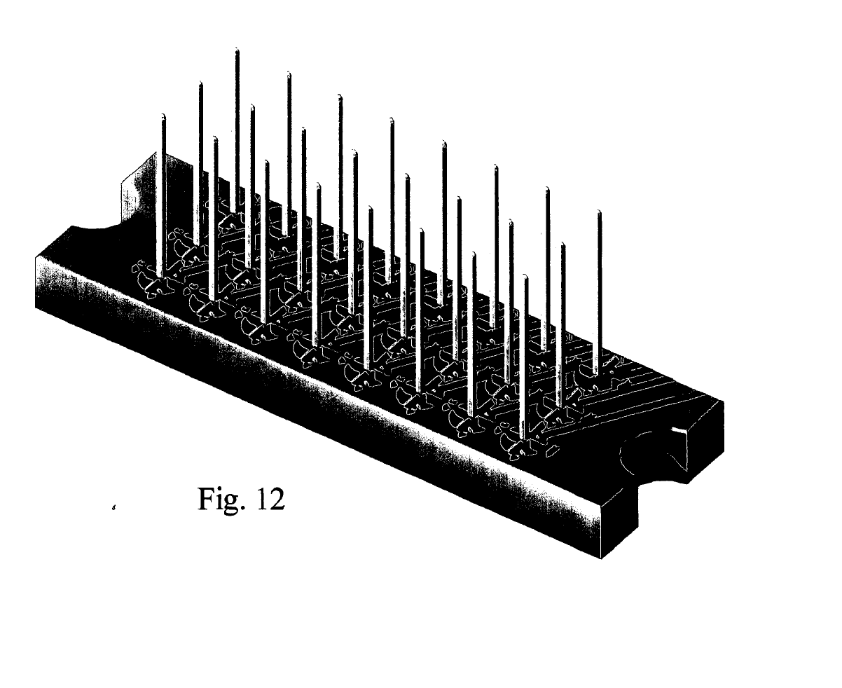

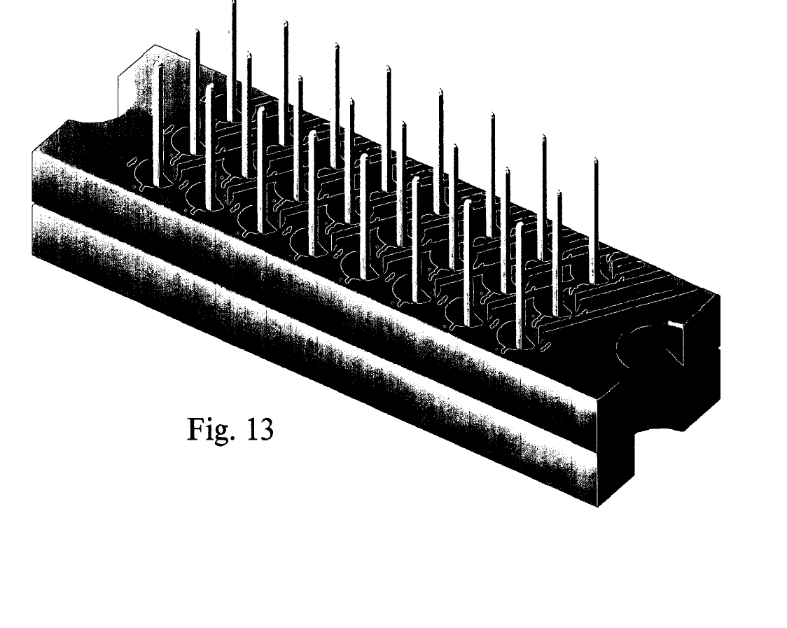

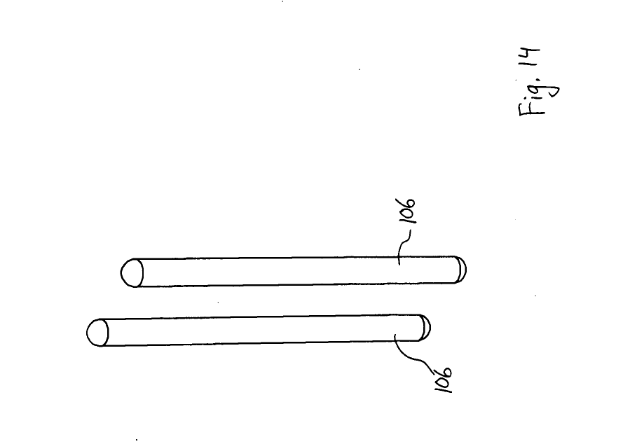

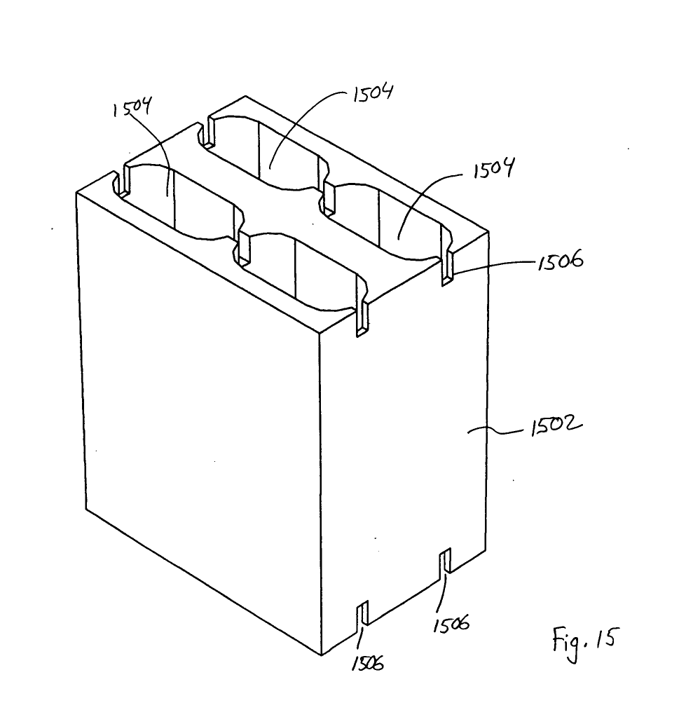

Referring to FIG. 7, a partial cross-sectional view of an alternative cable assembly 700, in accordance with the present invention, is shown in which a printed circuit board 702, for positioning and holding conductors 106, is itself attached to body 704 of cable assembly 700 by means of being riveted to body 704. Rivets 706 are shown to fasten printed circuit board 702 to body 704. Rivets 704 may be formed from an electrically conductive or an electrically insulating material.

Referring to FIG. 8, a partial cross-sectional view of an alternative cable assembly 800, in accordance with the present invention, is shown in which a secondary injection molding of, for example, Teflon or PTFE, provides a dielectric material 802 within the opening disposed between the shield (i.e., conductive body 804) and conductors 106.

Referring to FIG. 9, a cross-sectional view of a twinax cable assembly 900, in accordance with the present invention, is shown in which a highly conductive body 902 has openings 104 therethrough, and two conductors 106 disposed in each of openings 104, conductors 106 which are held in place by dielectric sheets 908, such as for example, polyimide, disposed on top and bottom surfaces of body 902. Body 902 may include structures 910 which are suitable for fitting and attaching dielectric sheets 908 to body 902.

FIG. 10 is top view of twinax cable assembly 900 of FIG. 9.

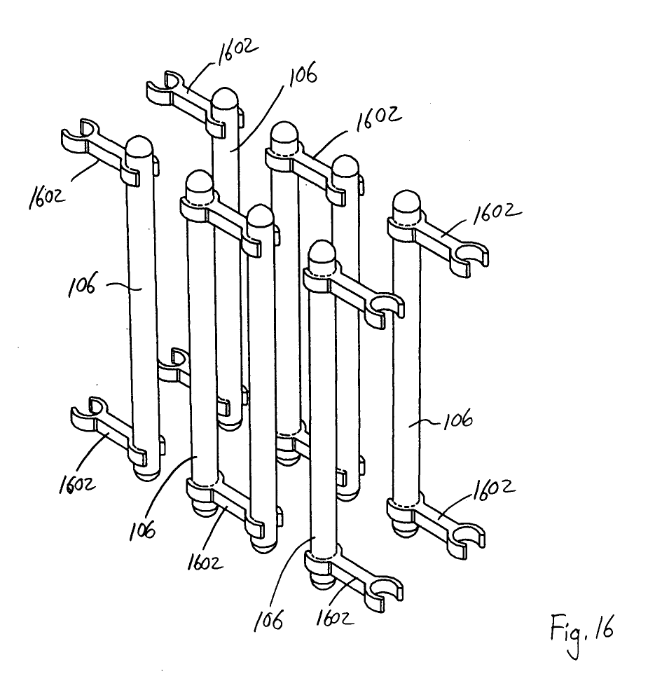

FIGS. 14-17 illustrate the components and assembly of a twinax cable in accordance with the present invention. More particularly, FIG. 14 shows a pair of spaced apart, substantially parallel conductors 106 that are used to form a twinaxial communication path. FIG. 15 shows electrically conductive body 1502 having openings 1504 through which pairs of conductors 106 are placed to form a plurality of twinaxial communication paths. By virtue of its electrical conductivity, body 1502 serves as the ground shield for conductors 106 passing therethrough. Conductive body 1502 may be a unitary structure, or may be formed of slices having opening therein, and having at least two slices that include notches for receiving support members. Conductive body 1502 also includes notches 1506, as shown, which are used to receive support members that hold conductors 106 in place. The present invention is not limited to the particular notches which are illustrated in FIG. 15, but includes any suitably shaped recess that is capable of receiving support members that hold the conductors in a spaced apart relationship.

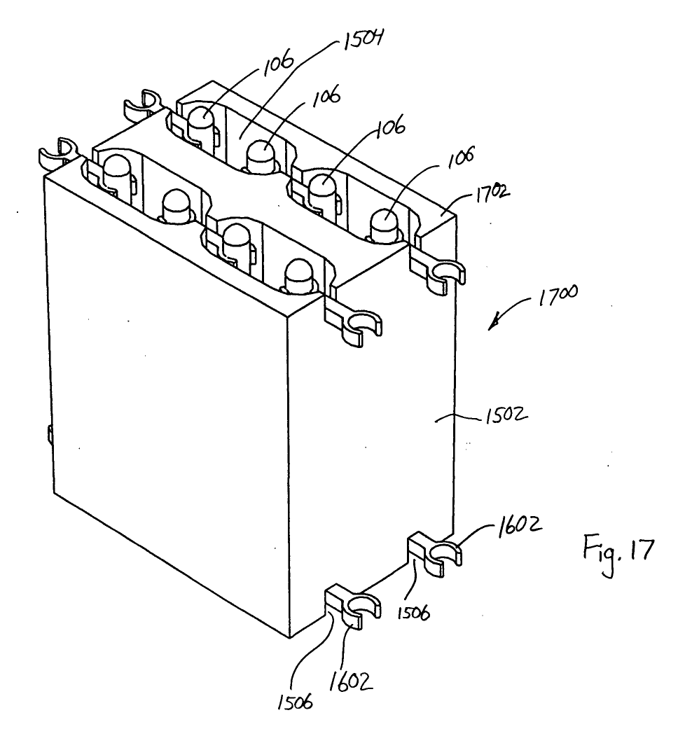

Referring to FIG. 16, the spatial relationship between pairs of conductors 106 and support members 1602 that are used to position conductors 106 within openings 1504 of body 1502 are shown. Support members 1602 are electrically insulating so as not to form an electrical short between the conductors 106 to which they are attached. FIG. 17 illustrates an assembly 1700 in which a plurality of twinaxial communication paths are provided through common body 1502. It can be seen that support members 1602 fit within openings 1504 and notches 1506. As shown in FIG. 17, support members 1602 are provided at both ends of body 1502. It can further be seen that two conductors 106 are disposed in each opening 1504 so as to form a twinaxial communications path. It is noted that in this illustrative embodiment, each conductor 106 of a twinax pair is attached to a different set of support members 1602.

In the illustrative assembly 1700, individual conductors 106 are shown as being substantially coplanar with a surface 1702 of conductive body 1502. In this way, connection may be made between conductors 106, and the electrical nodes to which it is desired to connect them by means of, for example, disposing an anisotropically conductive sheet between surface 1702 and the target electrical nodes (e.g., contact pads). In various embodiments, conductive body 1502 includes structures which facilitate clamping, or otherwise attaching, to a board or component which includes the target contact pads.

Terminology

The term “substantially” as used herein, unless otherwise noted, is meant to indicate that a measurement, or characteristic, is within manufacturing tolerances for a given method, or process, of making, or assembling a product. For example, “substantially perpendicular” is meant to convey that two items are positioned at right angles with respect to each other, but taking into consideration the non-ideal aspects of real world manufacturing, it includes positioning with deviations from a right angle that are within the normally accepted manufacturing, or assembly tolerances.

Conductive liners, as used herein, refers to those structures and devices which are inserted into a body, and used in conjunction with providing a ground shield for the various conductors disposed within, and spaced apart from, the conductive liners. Conductive liners may also be referred to as sleeves, tubular inserts, or similar terms and formulations.

Connecting web, as used herein, refers to those structures that function to vertically and laterally “lock” together the slices of a stack, and to hold and position the conductors within the openings of the slices that form the stack. Connecting web may also be referred to as supporting framework, connecting frame, conductor holder, conductor placement director, or similar terms and formulations.

Conclusion

Embodiments of the present invention find application in conjunction with electronic products generally, including, but not limited to, computers, video game consoles, cellular telephones, and other electronic products in which high frequency signals are used.

Various embodiments of the present invention provide low-cost cable and/or connector assemblies that are easy to manufacture.

An advantage of some embodiments of the present invention includes high packing density.

A further advantage of some embodiments of the present invention is ease of connection to other circuit components or connectors.

A still further advantage of some embodiments of the present invention is that a combination cable, connector, and heat sink, can be formed as a single unit.

It is noted that many alternative embodiments in accordance with the present invention are possible. In one such alternative, one or more gases, other than air may be used as the dielectric material surrounding conductors in the openings of the body. Similarly, these spaces may be evacuated rather than filled with gas. By evacuated, it is meant that gas and/or material between the ground shield and conductors is removed such that the content of that space ranges from a complete vacuum to an environment containing one or more gases at less than atmospheric pressure. Other alternatives include use of liquid crystal display polymers as the dielectric material.

It is to be understood that the present invention is not limited to the embodiments described above, but encompasses any and all embodiments within the scope of the subjoined Claims and their equivalents.

1. An assembly, comprising:
a plurality of slices, disposed adjacent each other so as to form a stack of slices, the stack having a top surface and a bottom surface, each slice having a plurality of openings therethrough, the plurality of slices aligned such that the plurality of openings in each slice overlay each of the corresponding openings in the other slices of the stack so as to provide a plurality of openings through the stack, each opening having an inner surface, at least the inner surface of the openings of the slices being electrically conductive;
a plurality of conductors, at least one conductor of the plurality of conductors disposed through each one of the plurality of openings, each such conductor spaced apart from the respective inner surface of the opening through which it is disposed; and
a first dielectric sheet disposed above the top surface of the stack, the plurality of conductors extending through the first dielectric sheet and in physical contact therewith.

2. The assembly of claim 1, wherein at least one of the plurality of slices is electrically conductive.

3. The assembly of claim 1, further comprising a second dielectric sheet disposed on the bottom surface of the stack, the plurality of conductors extending through the first dielectric sheet and in physical contact therewith.

4. The assembly of claim 1, wherein the first dielectric sheet is in contact with the top surface of the stack.

5. The assembly of claim 3, wherein the plurality of conductors are held in place by the first and second dielectric sheets.

6. The assembly of claim 1, wherein the first dielectric sheet comprises polyimide.

7. The assembly of claim 4, wherein the space between the inner surface of the openings and the conductors disposed therethrough is filled with air.

8. The assembly of claim 4, wherein the space between the inner surface of the openings and the conductors disposed therethrough is filled with a gas.

9. The assembly of claim 1, wherein the slice that forms the top surface of the stack includes one or more structures for attaching the first dielectric sheet thereto.

10. An assembly, comprising:
a body having a top surface and a bottom surface, and further having a plurality of openings therethrough between the top surface and the bottom surface;
a plurality of electrically conductive liners, each one of the plurality of conductive liners disposed in one of the plurality of openings in the body;
a first electrically insulating sheet disposed on the top surface of the body and a second electrically insulating sheet disposed on the bottom surface of the body; and
a plurality of conductors, each conductor having a first end and a second end, each one of the plurality of conductors disposed within one of the plurality of conductive liners such that the conductive liners and conductors are space apart from each other, each one of the plurality of conductors further disposed such that the first end extends through the first electrically insulating sheet and the second end extends through the second electrically insulating sheet.

11. The assembly of claim 10, wherein the body comprises a plurality of slices, each slice having a plurality of openings therethrough.

12. The assembly of claim 10, wherein the body is a unitary structure.

13. The assembly of claim 11, wherein the at least one slice further comprises electrically conductive material disposed within the electrically insulating material.

14. The assembly of claim 12, wherein the body includes structures to which the first electrically insulating sheet is attached.

15. The assembly of claim 14, wherein the first electrically insulating sheet comprises polyimide.

16. An assembly, comprising:
a body having a top surface and a bottom surface, and further having a plurality of openings therethrough between the top surface and the bottom surface, the body comprised of an electrically conductive material;
a first electrically insulating sheet disposed on the top surface of the body and a second electrically insulating sheet disposed on the bottom surface of the body; and
a plurality of conductors, each conductor having a first end and a second end, at least one of the plurality of conductors disposed within each one of the plurality of openings such that the conductors are spaced apart from inner surfaces of the respective openings, each one of the plurality of conductors further disposed such that the first end extends through the first electrically insulating sheet and the second end extends through the second electrically insulating sheet.

17. The assembly of claim 16, wherein the plurality of openings are circular and only one conductor is disposed in each of the plurality of openings.

18. The assembly of claim 16, wherein the plurality of openings are non-circular and two conductors are disposed in each of the plurality of openings.

19. The assembly of claim 16, wherein the first electrically insulating sheet comprises polyimide.

20. The assembly of claim 16, wherein the body includes structures for attaching the first and the second electrically insulating sheets.
